(19) United States
(12) Patent Application Publication
(10) Pub. No.: US 2015/0170555 A1
(43) Pub. Date: Jun. 18, 2015

(54) Display for Use in Managing Movement of a Patient

(71) Applicant: Safe Moves Injury Prevention Solutions Inc., Winnipeg (CA)

(72) Inventors: Robin Diduch, Winnipeg (CA); Matthew Peter Braun, Niverville (CA)

(21) Appl. No.: 14/105,697

(22) Filed: Dec. 13, 2013

(51) Int. Cl. G09F 11/23; G09F 19/02; G09F 7/00

(52) U.S. Cl. CPC G09F 11/232; G09F 7/00; G09F 19/02

(57) ABSTRACT

A system is provided for communicating to care givers in readily visible graphical form information relating to a) the status of a patient concerning a required mode of transfer of the patient when assisted by a caregiver from one surface to another, such as a bed to a wheelchair, toilet, regular chair, shower chair etc b) a required mode of bed mobility within a bed of a patient when assisted by the caregiver and c) a mode of mobility of the patient so that the caregiver can immediately see the status of the patient concerned for safe treatment of that patient. Each of the display elements has the graphics on a disk movable relative to a respective window in a substrate so as to move a selected one of the graphics to the window to be displayed.

This invention relates to a display apparatus for use in managing movement of a patient by providing information to care-givers as to the requirements of the patient concerned.

### BACKGROUND OF THE INVENTION

Safety requirements in recent years for managing movement of patients have dramatically become more important so that it is highly desirable to ensure that caregivers are properly informed of the requirements of specific patients to reduce risk to the patients and to the caregivers during such movements.

### SUMMARY OF THE INVENTION

It is one object of the invention to provide a display apparatus for use in managing movement of a patient.

According to one aspect of the invention there is provided a display apparatus for use in managing movement and safety of a patient comprising:

a substrate for supporting elements to be displayed;

a first plurality of first display elements each having graphics illustrating a respective one of a plurality of alternative modes of transfer of a patient assisted by a caregiver from one surface to another;

a second plurality of second display elements each having graphics illustrating a respective one of a plurality of alternative modes of bed mobility within a bed of a patient assisted by a caregiver;

the substrate providing a first location for displaying a selected one of the first display elements;

the substrate providing a second location for displaying a selected one of the second display elements.

The movement from one surface to another could be from a bed to wheelchair or other mobility device or it could be wheelchair to toilet, shower chair etc.

Preferably each of the first and second locations is defined by a respective window in the substrate at which a respective one of the display elements is visible and wherein each of the first and second display elements has the graphics thereon movable relative to the window so as to move a selected one of the graphics to the window to be displayed. However other means of mounting of the display elements can be provided including using magnetic elements attached to board.

Preferably each of the display elements comprises a disk mounted on the substrate for rotation about a center axis thereof at right angles to the substrate with the graphics arranged thereon at angularly spaced positions around the axis so as to rotate a selected one of the graphics to a window in the substrate to be displayed. However other means of moving of the display elements can be provided including sliding linear display strips.

Preferably the substrate comprises two overlying sheets so that the disk is contained between the two sheets rotatable about a pin connecting the two sheets and is only visible at the window.

Preferably the first and second locations are arranged side by side on the substrate.

Preferably there is provided a third plurality of third display elements each having graphics illustrating a respective one of a plurality of alternative modes of mobility of a patient.

Preferably the third display elements provide alternative modes of mobility of a patient within a room of the patient and a fourth set is provided including fourth display elements each having graphics illustrating a respective one of a plurality of alternative modes of mobility of a patient outside the room of the patient.

Preferably there is provided a fifth plurality of fifth display elements each having graphics illustrating a respective one of a plurality of alternative levels of risks of fall of the patient.

Preferably the graphics on the first display elements are arranged to illustrate the modes of transfer from surface to surface, from independent movement by the patient through different modes through to a full supported lift system.

Preferably the graphics on the second display elements are arranged to illustrate the modes of mobility within the bed for the patient from independent movement by the patient through to maximum assist using a stated number of assistants.

Preferably the graphics on the third display elements are arranged to illustrate the modes of mobility for the patient from independent walking movement through a cane, a walker through to an assistant propelled wheelchair.

Preferably the substrate carries a portion which can be moved from a position hidden behind the substrate to an exposed position and carries a plurality of designated areas for entering notes relating to the patient for personalization of the patient with the caregivers.

Preferably the portion is rotatable about a pin on the substrate so that the portion hangs downwardly from the pin at the bottom of the substrate when moved to the exposed position.

Preferably the substrate is formed of a plastics material which can be marked and erased and contains one or more areas designated for written notes to be added.

According to a more specific and detailed optional arrangement of the invention there is provided a display apparatus for use in managing movement of a patient comprising:

a substrate for supporting elements to be displayed;

a first plurality of first display elements each having graphics illustrating a respective one of a plurality of alternative modes of transfer of a patient assisted by a caregiver from one surface to another;

a second plurality of second display elements each having graphics illustrating a respective one of a plurality of alternative modes of bed mobility within a bed of a patient assisted by a caregiver;

a third plurality of third display elements each having graphics illustrating a respective one of a plurality of alternative modes of mobility of a patient within a room of the patient;

a fourth plurality of fourth display elements each having graphics illustrating a respective one of a plurality of alternative modes of mobility of a patient outside the room of the patient;

a fifth plurality of fifth display elements each having graphics illustrating a respective one of a plurality of alternative levels of risks of fall of the patient;

the substrate providing a first, second, third, fourth and fifth location for displaying a selected one of the first, second, third, fourth and fifth display elements;

wherein the substrate is formed of a plastics material which can be marked and erased and contains one or more areas designated for written notes to be added.

### BRIEF DESCRIPTION OF THE DRAWINGS

One embodiment of the invention will now be described in conjunction with the accompanying drawings in which:

FIG. 1 is a front elevational view of a first embodiment of an apparatus according to the present invention.

FIGS. 2, 3, 4 and 5 are plan views of separate disks arranged to be turned to locate individual selected graphic displays at a window on the substrate which display different information for the caregiver concerning the mobility of the patient.

FIG. 6 is a front elevational view of a second more simplified embodiment of an apparatus according to the present invention.

In the drawings like characters of reference indicate corresponding parts in the different figures.

### DETAILED DESCRIPTION

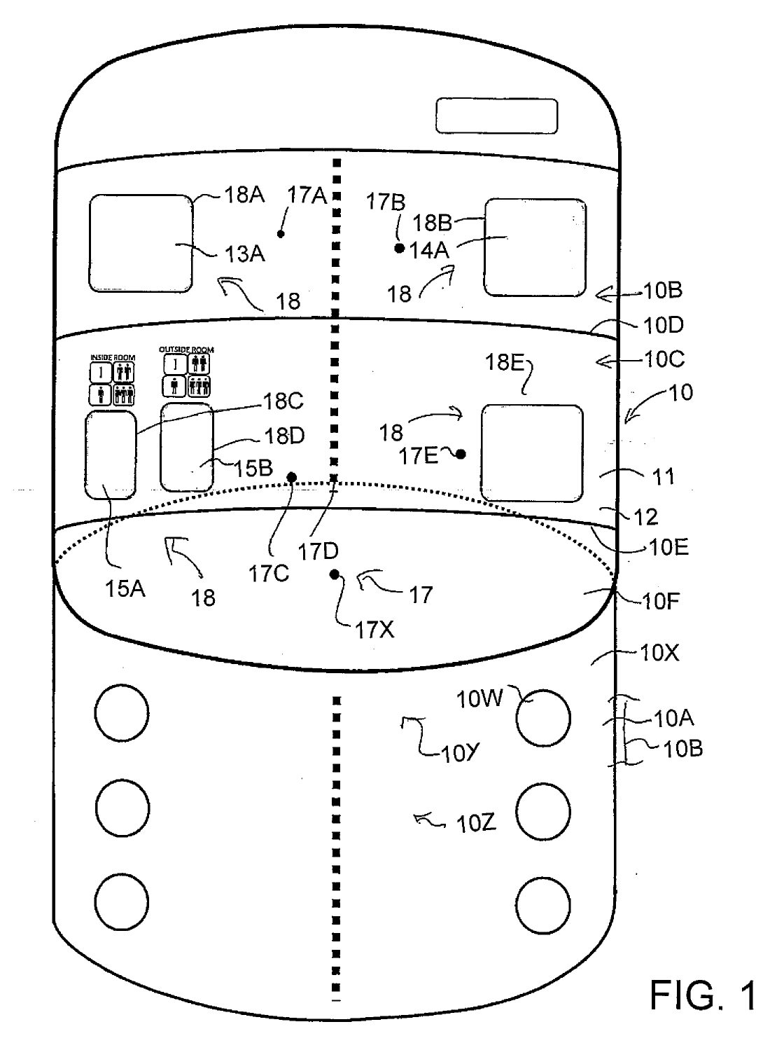

A first embodiment is shown in FIG. 1 and comprises a flat rectangular board 10 arranged to be located on a wall or adjacent the bed of a patient. The board has a front face 11 with a coating 12 of a known characteristic which is arranged to form a wet/dry erase board for marking with desired graphics or words. The front face of the board carries printing graphics on it as shown in FIG. 1.

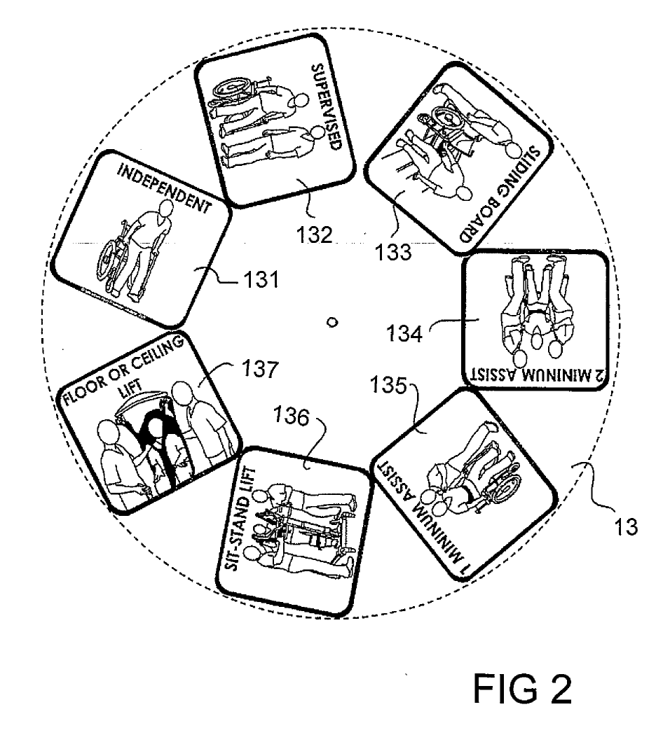

The board 10 is arranged for use in managing movement of a patient and comprises two overlying sheets 10A, 10B with a plurality of disks 13, 14, 15 and 16 shown respectively in FIGS. 2 to 5 contained between the two sheets with each being rotatable about a respective pin of a plurality of pins 17 connecting the two sheets. Each disk has a portion thereof which is visible at a respective window of a plurality of windows 18 so that a selected portion of the disk is only visible at the window selected.

The display elements include a first plurality of first display elements 13 having graphics illustrating a respective one of a plurality of alternative modes of transfer of a patient assisted by a caregiver from a bed to a mobility device. The display element 13 is a circular disk shown in FIG. 2 having a portion 13A visible at a first window 18A and is mounted on a first pin 17A for manual rotation by frictional contact with a finger of the caregiver at the window to present one of the graphical elements at the rectangular window 18A.

The graphics on the disk 13 as shown in FIG. 2 of the first display elements are arranged to illustrate the modes of transfer from one surface to another surface, from independent movement by the patient through different modes through to a full supported lift system. That is the graphics provide seven illustrations from the minimum condition of the patient through to a maximum condition of the patient. That is the graphics show the following conditions:

131-independent mobility by the patient without any assistance;

132-independent mobility by the patient without supervised assistance only;

133-independent mobility by the patient using a sliding board assistance from the bed surface;

134-assisted mobility of the patient with assistance by two caregivers;

135-assisted mobility of the patient with assistance by a single caregiver;

136-assisted mobility of the patient using a sit/stand lift;

137-assisted mobility of the patient using a full ceiling or floor lifting system.

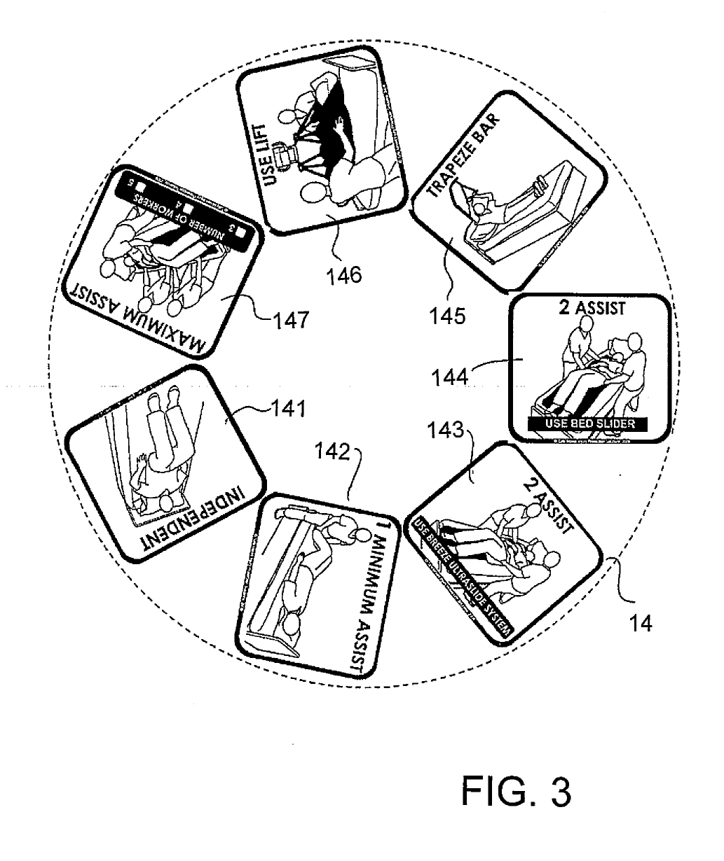

The display elements include a second plurality of second display elements 14 each having graphics illustrating a respective one of a plurality of alternative modes of bed mobility within a bed of a patient assisted by a caregiver. The display element 14 is also a circular disk shown in FIG. 3 having a portion 14A visible at a second window 18B and is mounted on a second pin 17B for manual rotation by the caregiver at the window to present one of the graphical elements at the rectangular window 18B.

The graphics on the second display elements 14 are arranged to illustrate the modes of mobility within the bed for the patient from independent movement by the patient through to maximum assist using a stated number of assistants. That is the graphics provide seven illustrations from the minimum condition of the patient through to a maximum condition of the patient. That is the graphics show the following conditions:

141-independent mobility within the bed by the patient without any assistance;

142-independent mobility by the patient without minimum assistance only;

143-mobility by the patient using a Breeze sliding board assistance with two caregivers;

144-assisted mobility of the patient using a bed slider with assistance by two caregivers;

145-assisted mobility of the patient with assistance from a trapeze bar;

146-assisted mobility of the patient using a lift;

147-maximum assisted mobility of the patient using a full ceiling or floor lifting system and a stated number of caregivers.

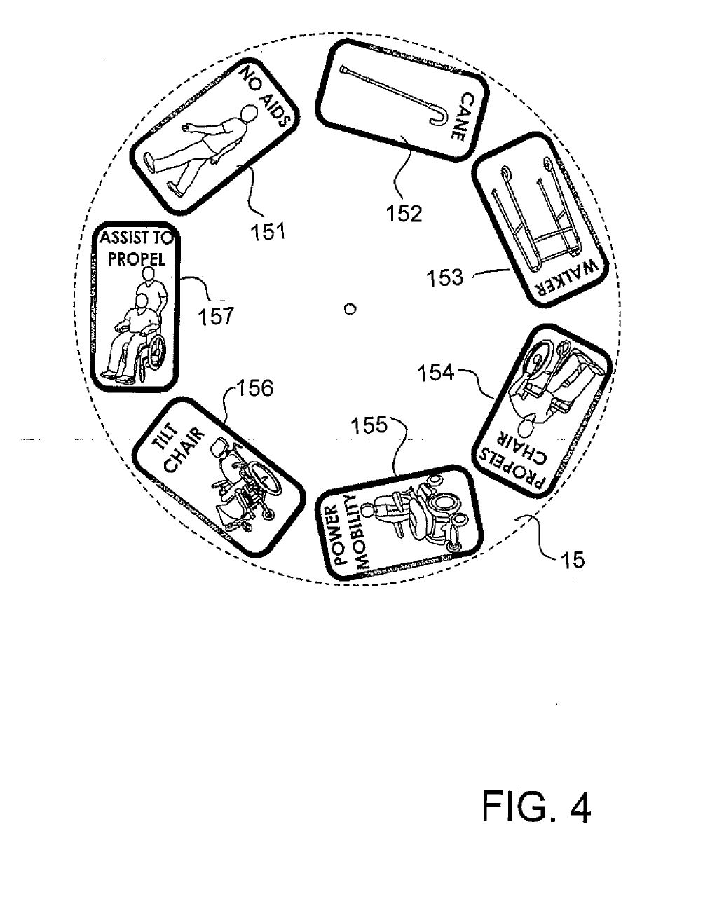

The display elements include a third plurality of second display elements 15 each having graphics illustrating a respective one of a plurality of alternative modes of mobility of a patient. The display element 15 is also a circular disk shown in FIG. 4 having a portion 15A visible at a third window 18C and is mounted on a third pin 17C for manual rotation by the caregiver at the window to present one of the graphical elements at the rectangular window 18C.

The graphics on the third display elements are arranged to illustrate the modes of mobility for the patient from independent walking movement through a cane, a walker through to an assistant propelled wheelchair. That is the graphics provide seven illustrations from the minimum condition of the patient through to a maximum condition of the patient. That is the graphics show the following conditions:

151-independent mobility by the patient without any aids;

152-independent mobility by the patient using a cane;

153-independent mobility by the patient using a walker;

154-independent mobility by the patient using a self-propelled wheel chair;

155-independent mobility by the patient using a powered wheel chair;

156-assisted mobility of the patient using a tilt chair;

157-assisted mobility of the patient using a propelled wheel chair and assistance from the caregiver.

The window 18C is arranged to display information concerning the mobility of the patient while in the patient's room. The display elements further include a fourth plurality of fourth display elements each having graphics illustrating a respective one of a plurality of alternative modes of mobility of a patient outside the room of the patient. This uses a disk identical to the disk 15 which shows a selected image 15B at the window 18D alongside the window 18C.

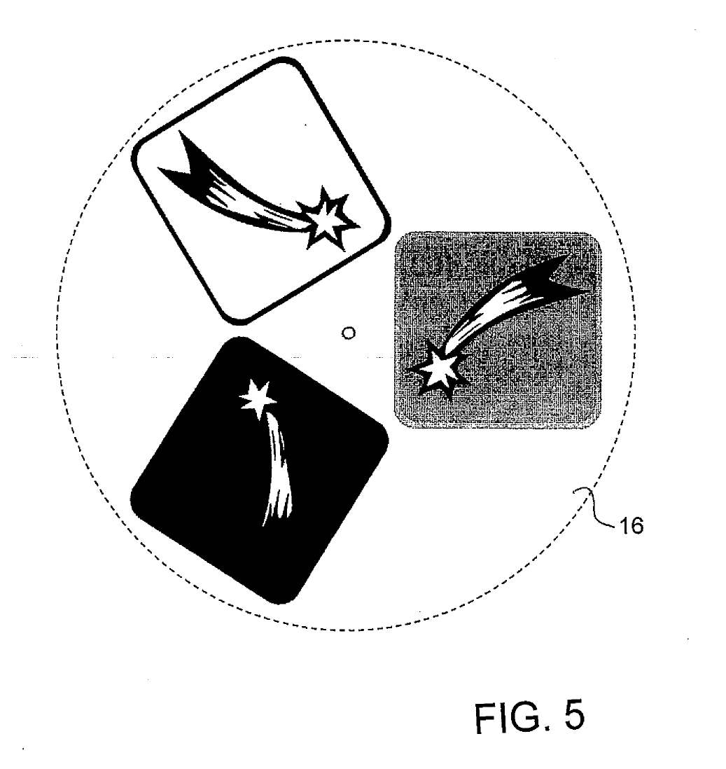

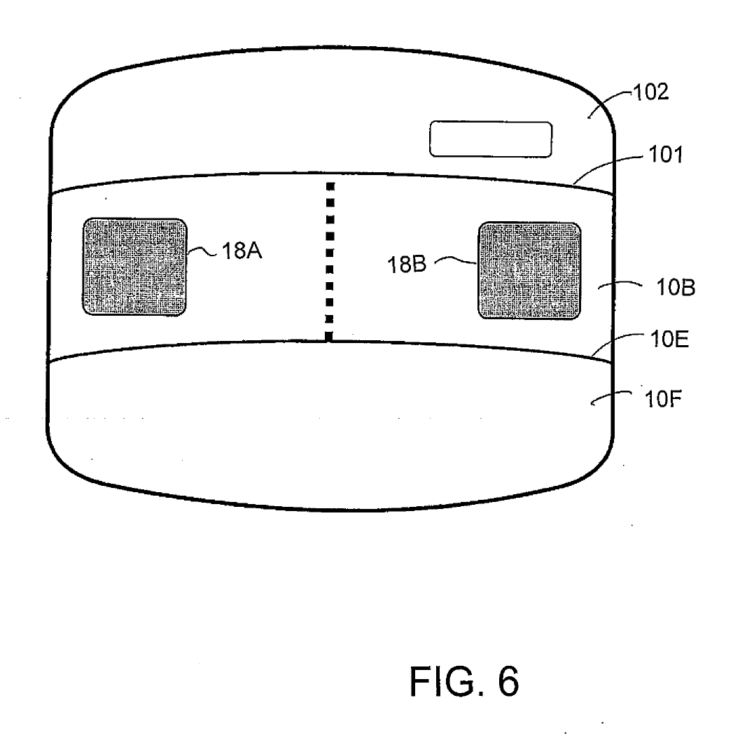

The display elements include a fifth plurality of fifth display elements each having graphics illustrating a respective one of a plurality of alternative levels of risks of fall of the patient shown in FIG. 6 which include yellow, orange or red images of a fall to indicate the level of risk for this patient. Thus disk shown in FIG. 5 at disk 16 is mounted on a pin 17E for display of the selected image at the window 18E.

The substrate provides the first 18A, second 18B, third 18C, fourth 18D and fifth 18E locations for displaying a selected one of the first, second, third, fourth and fifth display disk elements. These are arranged with the windows 18A and 18B at a top area 10C of the panel side by side. The windows 18C and 18D are immediately adjacent underneath the window 18A. The window 18E is symmetrical to the window 18B so that the windows 18E together with the pair 18C, 18D are arranged in a second pair in a second area 10C of the panel divided by a line 10D.

The substrate is formed of a plastics material which can be marked and erased and contains one or more areas 10F at the bottom designated for written notes to be added divided from the area 10C by a line 10E.

The substrate further carries a portion 10X which can be moved from a position hidden behind the substrate to an exposed position shown in FIG. 1 and carries a plurality of designated areas 10Y, 10Z for entering notes at a symbol 10W which provides an indication of the notes to be added concerning the patient. The portion 10X is rotatable about a pin 17X on the substrate so that the portion 10X hangs downwardly from the pin at the bottom of the substrate when moved to the exposed position. The portion 10X is formed of a plastics material which can be marked and erased and contains one or more areas designated for written notes to be added.

In FIG. 6 is shown a simplified version of the device where there is provided only he area 10B containing the windows 18A and 18B and the bottom portion 10F separated by the line 10E. A top section 102 divided from the area 10B by a line 101 provides an area for identifying the patient. The portion 10X is also omitted from this version.

1. A display apparatus for use in managing movement of a patient comprising:
a substrate for supporting elements to be displayed;
a first plurality of first display elements each having graphics illustrating a respective one of a plurality of alternative modes of transfer of a patient assisted by a caregiver from a bed to a wheel chair;
a second plurality of second display elements each having graphics illustrating a respective one of a plurality of alternative modes of bed mobility within a bed of a patient assisted by a caregiver;
the substrate providing a first location for displaying a selected one of the first display elements;
the substrate providing a second location for displaying a selected one of the second display elements.

2. The display apparatus according to claim 1 wherein each of the first and second locations is defined by a respective window in the substrate at which a respective one of the display elements is visible and wherein each of the first and second display elements has the graphics thereon movable relative to the window so as to move a selected one of the graphics to the window to be displayed.

3. The display apparatus according to claim 2 wherein each of the display elements comprises a disk mounted on the substrate for rotation about a center axis thereof at right angles to the substrate with the graphics arranged thereon at angularly spaced positions around the axis so as to rotate a selected one of the graphics to a window in the substrate to be displayed.

4. The display apparatus according to claim 3 wherein the substrate comprises two overlying sheets so that the disk is contained between the two sheets rotatable about a pin connecting the two sheets and is only visible at the window.

5. The display apparatus according to claim 1 wherein the first and second locations are arranged side by side on the substrate.

6. The display apparatus according to claim 1 wherein there is provided a third plurality of third display elements each having graphics illustrating a respective one of a plurality of alternative modes of mobility of a patient.

7. The display apparatus according to claim 1 wherein there is provided a third plurality of third display elements each having graphics illustrating a respective one of a plurality of alternative modes of mobility of a patient within a room of the patient.

8. The display apparatus according to claim 7 wherein there is provided a fourth plurality of fourth display elements each having graphics illustrating a respective one of a plurality of alternative modes of mobility of a patient outside the room of the patient.

9. The display apparatus according to claim 1 wherein there is provided a fifth plurality of fifth display elements each having graphics illustrating a respective one of a plurality of alternative levels of risks of fall of the patient.

10. The display apparatus according to claim 1 wherein the graphics on the first display elements are arranged to illustrate the modes of transfer to a wheel chair from independent movement by the patient through different modes through to a full supported lift system.

11. The display apparatus according to claim 1 wherein the graphics on the second display elements are arranged to illustrate the modes of mobility within the bed for the patient from independent movement by the patient through to maximum assist using a stated number of assistants.

12. The display apparatus according to claim 1 wherein the graphics on the third display elements are arranged to illustrate the modes of mobility for the patient from independent walking movement through a cane, a walker through to an assistant propelled wheelchair.

13. The display apparatus according to claim 1 wherein the substrate carries a portion which can be moved from a position hidden behind the substrate to an exposed position and carries a plurality of designated areas for entering notes

14. The display apparatus according to claim 13 wherein the portion is rotatable about a pin on the substrate so that the portion hangs downwardly from the pin at the bottom of the substrate when moved to the exposed position.

15. The display apparatus according to claim 1 wherein the substrate is formed of a plastics material which can be marked and erased and contains one or more areas designated for written notes to be added.

16. A display apparatus for use in managing movement of a patient comprising:
a substrate for supporting elements to be displayed;
a first plurality of first display elements each having graphics illustrating a respective one of a plurality of alternative modes of transfer of a patient assisted by a caregiver from a bed to a mobility device;
a second plurality of second display elements each having graphics illustrating a respective one of a plurality of alternative modes of bed mobility within a bed of a patient assisted by a caregiver;
a third plurality of third display elements each having graphics illustrating a respective one of a plurality of alternative modes of mobility of a patient within a room of the patient;
a fourth plurality of fourth display elements each having graphics illustrating a respective one of a plurality of alternative modes of mobility of a patient outside the room of the patient;
a fifth plurality of fifth display elements each having graphics illustrating a respective one of a plurality of alternative levels of risks of fall of the patient;
the substrate providing a first, second, third, fourth and fifth location for displaying a selected one of the first, second, third, fourth and fifth display elements;
wherein the substrate is formed of a plastics material which can be marked and erased and contains one or more areas designated for written notes to be added.

17. The display apparatus according to claim 16 wherein each of the first, second, third, fourth and fifth locations is defined by a respective window in the substrate at which a respective one of the display elements is visible and wherein each of the first, second, third, fourth and fifth display elements has the graphics thereon movable relative to the window so as to move a selected one of the graphics to the window to be displayed.

18. The display apparatus according to claim 16 wherein each of the display elements comprises a disk mounted on the substrate for rotation about a center axis thereof at right angles to the substrate with the graphics arranged thereon at angularly spaced positions around the axis so as to rotate a selected one of the graphics to a window in the substrate to be displayed.

19. The display apparatus according to claim 18 wherein the substrate comprises two overlying sheets so that the disk is contained between the two sheets rotatable about a pin connecting the two sheets and is only visible at the window.
